(19) United States
(12) Patent Application Publication
(10) Pub. No.: US 2009/0078468 A1
(43) Pub. Date: Mar. 26, 2009

(54) ROCK DRILL MACHINE

(76) Inventor: Hannu PAASONEN, Nokia (FI)

Correspondence Address: STITES & HARBISON PLLC, 1199 NORTH FAIRFAX STREET, SUITE 900, ALEXANDRIA, VA, 22314, US

(21) Appl. No.: 11/861,783

(22) Filed: Sep. 26, 2007

(51) Int. Cl. B25D 9/04

(52) U.S. Cl. 175/322

(57) ABSTRACT

A rock drilling machine comprising a frame (3, 4), arranged inside the frame a drill rod (2) movable in axial direction, an arrangement (5) to rotate drill rod (2), a hammer gear, by means of which hammering pulses are generated into a piston (1), which is arranged to hammer the drill rod (2) rear end, in order to transmit hammering pulses through the drill rod into the drilling equipment, attachable to the drill rod front end, and further, in this drilling machine there is arranged around the drill rod a position sleeve (9) and an arrangement to move position sleeve in axial direction against hammering piston (1) so that counter surface (13) in position sleeve (9) meets counter surface (12) in drill rod (2) whereby, on continuing the said positioning, drill rod (2) is movable to the point wanted. Counter surface (13) belonging to position sleeve (9) is formed in the piece, most properly ring (10), which by means of spring element (11) is arranged to flex in regard to the other structure of position sleeve (9), and that in drilling situation position sleeve (9) is arranged to be freely backing against the front side of the drilling machine, when in drilling situation the positioning impact on the position sleeve against hammering piston (1) is removed.

This invention relates to a rock drill machine comprising a frame, arranged inside the frame a drill rod movable in axial direction, an arrangement to rotate the drill rod, a hammer gear, by means of which hammering pulses are generated to the piston, which is arranged to hammer the drill rod rear end, in order to transmit hammering pulses through the drill rod, attachable to the drilling equipment, for drilling the drill rod front end, and further, there is in this drilling machine arranged around the drill rod a position sleeve and an arrangement in order to move the position sleeve in axial direction towards the hammering pistons so that a counter surface in the position sleeve meets the a counter surface in the drill rod, whereby the drill rod can be moved to the d hammering point wanted, while continuing the said positioning motion.

Previously known from Finnish patent publication 114903 is a rock drill machine like the one presented, to w hose pulling gear that moves the drill rod during rock drilling a force in the opposite is directed, which moves the pulling gear forwards and keeps it at a specified distance from the position corresponding to the hammering point of the drill rod. When the drilling equipment is pulled out from the hole, the pulling gear is moved towards the hammering piston, causing transmission force in the pulling gear. Such special most usable percussion like working is needed in pulling the drilling equipment out of the drill hole, since often the drill tries to wedge into the hole while being removed from the hole.

The disadvantage of the solution according to publication FI-114903 is that for the pulling gear a moving arrangement in both directions is needed. When the movements are done by means of pressure medium the cylinder, piston and packing solutions become quite complicated. In addition, control valves are necessary for both positioning moves During pulling out the drilling equipment hammering pulses arise strongly into the drill frame, since there are no spring elements.

By means of a rock drilling machine according to the invention the need of many positioning movements and their controls are avoided. Only one moving direction has to be carried out, when the return movement in opposite direction takes freely place during operation of the drilling machine. During pulling out the drilling equipment there is due to the simple spring-arrangement a strong tendency to pull-off the impulses, whereby the drill is not strained by harmful hammering as much as in known solutions. Also the behaviour of the drilling by pulling out according to the solution of the invention departs essentially from known solutions, since energy bound to flexibility throws the drilling equipment backwards in regard to the frame in a quite other way, which is effective, among other things, in pulling out the drilling equipment from the hole, if it has already got stuck. It is easy to form one cylinder space in the drill frame as well as placing a piston furnished with one pressure surface in it.

In the following the invention is disclosed with reference to the enclosed drawing, where

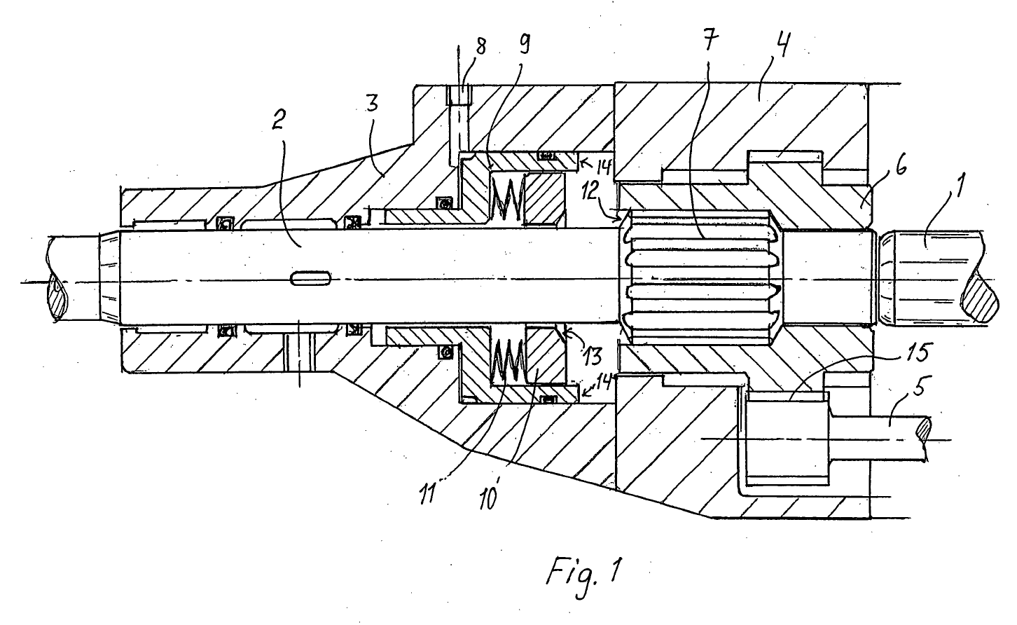

FIG. 1 shows a side section view of the rock drilling machine in drilling position,

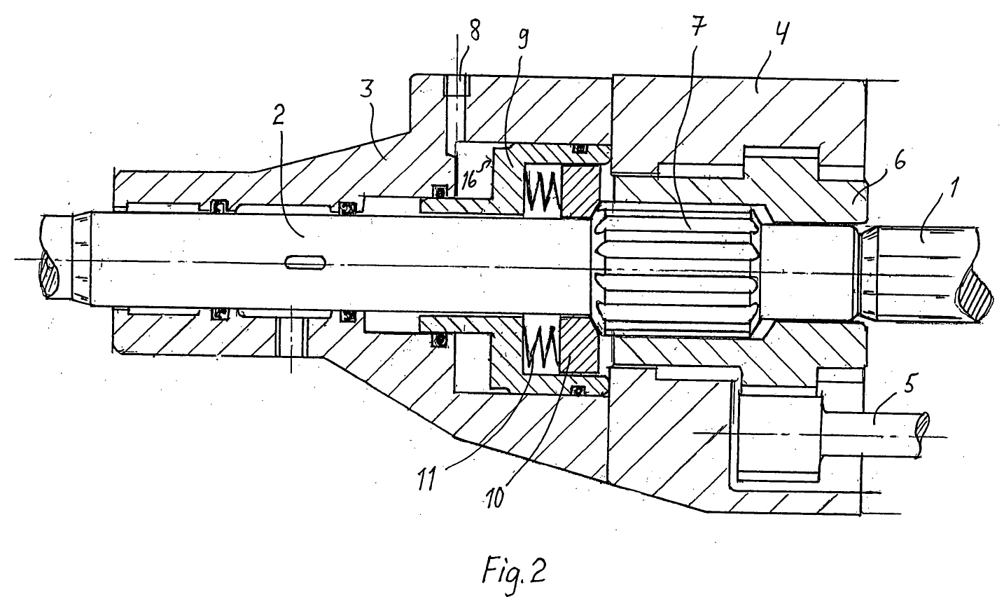

FIG. 2 shows a side section view of the rock drilling machine in pulling out position.

FIG. 1 shows the rock drilling machine furnished with a frame 3 and 4, where there is inside the frame a drill rod 2 movable and rotating in axial direction. Drill rod 2 is rotated by means of rotation axle 5 coming from the turning gear, and from which, by way of rack transmission 15, the rotation is led to outside sleeve 6 of drill rod 2. The inside hole of sleeve 6 is grooved and, correspondingly, there is in drill rod 2 a grooving 7, which transmits the rotation to drill rod 2 and allows the drill rod to move also in axial direction as much as needed. In the drilling situation presented by FIG. 1 the back and forth moving piston 1, which produces hammering pulses, hammers the back end of drill rod 2 and produces in the drill rod a function transmitting hammering pulses forward. In front of drill rod 2 the hammering drilling equipment is connected, which gets the hammering pulses transmitted by drill rod 2.

The drilling machine has according to the invention a position sleeve 9 that positions the drill rod 2, which in this drilling situation is freely drifted to its foremost position, due to which it is so far from counter shoulder surface 12, which belongs to drill rod 2, that counter surface 12 does not reach to counter surface 13, which belongs to position sleeve 9, when drill rod 2 is making back and forth motion which belongs to the drilling situation. In the drilling situation shown by FIG. 1, piston 1 that produces back and forth moving hammering pulses, hammers the back most possible and the most wanted position always the moment piston 1 hammers the back end of drill rod 2. Due to hammering pulses drill rod 2 moves a few millimetres forward and returns back. Position Sleeve 9 works like a piston in the cylinder space formed in the drilling machine 3 frame. No pressure medium is led through channel 8 to the cylinder space in drilling situation, but the pressure medium is let to flow out from the cylinder space so that position sleeve 9 can drift to the position presented in FIG. 1 and stay there. Ultimately, the counter surface 12 of drill rod 2 hammers position sleeve 9 into ring 10 and moves the position sleeve 9 to the position of FIG. 1.

By means of the new simple position sleeve 9 solution according to the invention hammering pulses are easily produced, which assist the pulling out of the drilling equipment from the hole.

On pulling out the drilling equipment, by means of piston 1, hammering pulses are produced, as even by hole drilling. By pulling out position sleeve 9 is moved towards hammering piston 1. FIG. 1 shows that position sleeve 9 has a distance, determined by counter surface 14, towards the drilling machine rear end, when it is moved in that direction. In this example moving of position sleeve 9 takes place by means of pressure medium, which is led through channel 8 against counter surface 16 of position sleeve 9. The pressure is left in channel 8 to effect the pulling out during the whole pull-of procedure. When position sleeve 9 is in FIG. 2 position, ring 10 to it belonging and to it connected through spring element 11, pushes drill rod 2 always to a starting position chosen towards the hammering piston. When piston 1 hammers, the hammering pulse goes from drill rod 2 to spring element as binding energy and a part of hammering moves to frame 3, 4. The drill equipment makes slight hammering in the hole. The binding energy in spring element 11 returns the drill rod with a strong pulse against the hammering piston and at the same time pulls also the drill equipment upwards in the hole.

On pulling out, while the hammering piston is producing pulses to drill rod 2, the impact of the pulses can be turned to pulses, which pull out the drill equipment from the hole by means of a positioning sleeve 9 according to the invention, and by means of spring element 11, which stores and transmits energy. By pulling out, frame 3, 4 of the drilling machine is pulled by appropriate force off the hole. Frame 3, 4 represents a great mass and drill rod 2 and the drilling equipment a small mass and thus fast motion. Pulling out the drilling equipment from the hole improves essentially when, to drilling equipment a small back and forth motion can be conveyed in addition to even pulling force.

1. A rock drill machine comprising a frame (3, 4), arranged inside the frame a drill rod (2) movable in axial direction, an arrangement (5) to rotate drill rod (2), a hammer gear, by means of which hammering pulses are generated into a piston (1), which is arranged to hammer the drill rod (2) rear end, in order to transmit hammering pulses through the drill rod into the drilling equipment, attachable to the drill rod front end, and further, in this drilling machine there is arranged around the drill rod a position sleeve (9) and an arrangement to move position sleeve in axial direction against hammering piston (1) so that the counter surface (13) in position sleeve (9) meets counter surface (12) in drill rod (2) whereby drill rod (2), on continuing the said positioning, is movable to the hammering point wanted, characterized in that counter surface (13) belonging to position sleeve (9) is formed into the piece, most usable a ring (10) which by means of spring element (11) is arranged to flex in regard to the other structure of position sleeve (9), and that in drilling situation position sleeve (9) is arranged to be freely backing against the front side of the drilling machine, when in drilling situation the positioning impact on the position sleeve against hammering piston (1) is removed.

2. A rock drill machine according to claim 1 characterized in that position sleeve (9) is arranged movable in the cylinder space formed in frame (3), whereby position sleeve (9) is a piston movable by means of medium in the cylinder space.

3. A rock drill machine according to claim 1 characterized in that position sleeve (9) has a counter surface (14) directed against hammering piston (1), which counter surface has in the drilling machine frame (4) a counter surface, in order to restrict the positioning of the position sleeve by means of counter faces to the intended point and at the same time to move drill rod (2) by means of the position sleeve towards hammering piston (1) the to intended point in pulling the drilling equipment out from the hole to the indented point, when the drilling equipment is pulled out from the hole still producing hammering pulses.

4. A rock drilling machine according to claim 1 characterized in that position sleeve (9) has a cup spring (11) as spring element.
